(19) United States
(12) Patent Application Publication
(10) Pub. No.: US 2025/0136511 A1
(43) Pub. Date: May 1, 2025

(54) ALTERNATIVE MEANS OF PRESERVATION OF COATINGS/COMPOUNDS

(71) Applicant: United States Gypsum Company, Chicago, IL (US)

(72) Inventors: Renee J. Weinberger, Waukegan, IL (US); Rafael Bury, Wheeling, IL (US)

(21) Appl. No.: 18/675,766

(22) Filed: May 28, 2024

Related U.S. Application Data
(60) Provisional application No. 63/546,588, filed on Oct. 31, 2023.

(51) Int. Cl. C04B 26/28; C04B 14/10; C04B 14/18; C04B 14/20; C04B 14/28; C04B 22/14; C04B 103/67; C04B 111/00

(52) U.S. Cl. CPC C04B 26/28; C04B 14/102; C04B 14/104; C04B 14/106; C04B 14/18; C04B 14/206; C04B 14/28; C04B 22/142; C04B 2103/67; C04B 2111/00508; C04B 2111/00603

(57) ABSTRACT

A building construction composition, including wall and ceiling textures, joint compounds and coatings, the building construction composition comprising hydrated gypsum, anhydrous gypsum and/or calcium carbonate, a starch and/or polymeric binder and a formaldehyde-free antibacterial agent which contains one or more of the following compounds: copper (II) sulfate pentahydrate, copper sulfate, copper hydroxide, copper oxychloride, or any combination thereof; and methods for preventing microbial growth during manufacturing, storage and usage of the building construction compositions.

### CROSS-REFERENCE TO RELATED APPLICATIONS

This application claims the benefit of priority from the U.S. Provisional patent application 63/546,588 filed Oct. 31, 2923, the entire disclosure of which is herein incorporated in its entirety by reference.

### TECHNICAL FIELD

This disclosure relates to the field of building construction compositions, including paints, coatings, wall and ceiling textures and joint compounds comprising a formaldehyde-free antibacterial agent and methods for preventing microbial growth during manufacturing, storage and usage of the building construction compositions.

### BACKGROUND

Antimicrobial compounds are commonly used for protecting building construction compositions from microbial growth during manufacturing, storage and when these compositions are mixed with water prior to usage. Conventional preservatives for joint compounds and textures may contain formaldehyde and therefore, they are subject to restrictions for aqueous products comprising formaldehyde and formaldehyde-releasing preservatives.

Various attempts have been made to use antimicrobial compounds that can generate less VOC off-gassing and formaldehyde, for example as reported in US patent publication 20190373892, U.S. Pat. Nos. 8,975,321 and 10,822,274. However, in order to meet a VOC (Volatile Organic Compound) standard, there remains the need in the field for antimicrobial agents which are formaldehyde-free and can be used for protecting aqueous building construction compositions from microbial growth.

### SUMMARY

In one aspect, this disclosure provides a building construction composition comprising a formaldehyde-free preservative, wherein the formaldehyde-free preservative comprises a copper-containing compound.

A building construction composition according to this disclosure may comprise:
hydrated gypsum, anhydrous gypsum and/or calcium carbonate;
a starch and/or polymeric binder; and
a copper-containing compound.

In some preferred embodiments, the building construction composition may be in the form of a wall and ceiling texture, joint compound, paint or coating.

In some preferred embodiments, the building construction composition may comprise: hydrated gypsum, anhydrous gypsum, and/or calcium carbonate in an amount from about 30 wt % to about 90 wt % of the composition; the starch and/or polymeric binder in an amount from about 0.1 wt % to about 50 wt % of the composition; and the copper-containing compound in an amount from about 0.1 wt % to about 10 wt % of the composition.

Preferably, the copper-containing compound may be one or more of the following compounds: copper (II) sulfate pentahydrate, copper sulfate, copper hydroxide, copper oxychloride, or any combination thereof.

The building construction compositions according to this disclosure may be in the form of powder or they may comprise water. The building construction compositions according to this disclosure may comprise one or more of the following additives: a rheology modifying agent, a coloring pigment, a surfactant, a defoamer, fungicide, co-preservative, a thickener or any combination thereof.

Preferred building construction compositions may be substantially formaldehyde-free. In some embodiments, the building construction composition according to this disclosure may have bacterial resistance of 0 or 1 (minimal or trace bacterial growth) as measured 2 days post-plating on tryptic Soy Agar (TSA) 15 mm×100 min plate.

In another aspect, this disclosure provides methods for protecting aqueous building construction mixtures from microbial growth. One of technical advantages of the methods according to this disclosure is that these methods may be substantially VOC-free methods and preferably with a total concentration of volatile organic compounds in a range of less than 1000 ppm.

In yet another aspect, this disclosure relates to a method for protecting a building construction composition which comprises one or more of hydrated, anhydrous gypsum and/or calcium carbonate and one or more of a starch and/or polymeric binder from bacterial growth, wherein the method comprises: mixing the building construction composition with a copper-containing compound. Preferably, the copper-containing compound may be one or more of the following: copper (II) sulfate pentahydrate, copper sulfate, copper hydroxide, copper oxychloride, or any combination thereof. Preferably, the copper-containing compound may be added in an amount from about 0.1 wt % to about 10 wt % of the building construction mixture.

Embodiments of the method include those in which the building construction composition is being mixed with water in a mixer and the copper-containing compound is added to the mixer directly, or the copper-compound is premixed with dry components of the building construction composition before being added to the mixer. In some embodiments of the method, the building construction composition may be a dry mixture which does not contain water or liquid components.

In yet another aspect, this disclosure relates to a method for finishing an interior wall and/or ceiling surface, the method comprising:
a) mixing a wall and ceiling texture powder with water and a copper-containing compound, wherein said wall and ceiling texture powder comprises one or more of the following: calcium carbonate, hydrated gypsum, anhydrous gypsum, a starch, polymeric binder, or any combination thereof; and
b) applying the mixture over a primed or unprimed interior wall and/or ceiling surface and forming a texture pattern over said surface.

Embodiments of this method include those, wherein the method may be further characterized by one or more of the following features:
in step a), the wall and ceiling texture powder is premixed with the copper-containing compound prior to be mixed with water;
step b) includes spraying the mixture, applying the mixture with a brush, applying the mixture with a roller, or any combination thereof;
the method further comprises painting over the texture pattern after the texture pattern has dried;
the copper-containing compound is one or more of the following: copper (II) sulfate pentahydrate, copper sulfate, copper hydroxide, copper oxychloride, or any combination thereof; and/or
the copper-containing compound is added in an amount from about 0.1 wt % to about 10 wt % of the wall and ceiling texture powder.

In yet another aspect, this disclosure relates to a method for producing a building construction mixture in a mixer, the method comprising:
a) mixing with water in the mixer the building construction composition according to this disclosure; and
b) prior to step a) and/or after step a) contacting the mixer with a copper-containing compound.

In embodiments of the method, the method may be further characterized by one or more of the following features:
the copper-containing compound comprises copper (II) sulfate pentahydrate; and/or
the copper-containing compound is pre-mixed with water prior to contacting the mixer.

### DETAILED DESCRIPTION

In this disclosure, “wt %” means percentage by weight.

In this disclosure, “about” means a value plus/minus 5%. For example, “about 100” means 100±5 and “about 200” means 200±10.

In this disclosure, the term “composition” may be used interchangeably with the term “mixture” or “formulation.” Compositions include dry powder formulations which do not comprise water or liquid components as well as compositions in liquid (slurry) or paste form which comprise water and/or liquid components.

In this disclosure, volatile organic compounds may be abbreviated as VOCs. VOCs include compounds, such as formaldehyde, which can be emitted as gas from certain solids, such as for example, as a dry coating applied over a substrate or from a liquid or paste, such as for example as a gypsum slurry or a joint compound paste.

In this disclosure, a composition or a method may be referred to as substantially VOC-free when a total concentration of emitted volatile organic compounds is in a range of less than 1000 ppm.

In this disclosure, “a dry building construction composition” means that the dry building construction mixture does not contain aqueous water or liquid components. Preferably, the dry building construction composition may be in powder form. However, a dry composition or dry mixture may have some moisture content and may contain compounds with bound water molecules.

In this disclosure, the term “gypsum” may refer to any of the following: naturally mined gypsum (ore), landplaster and/or synthetic gypsum. “Gypsum” may include hydrated gypsum which comprises calcium sulfate dihydrate (CaSO₄·2H₂O), anhydrous gypsum which comprises calcium sulfate anhydrous (CaSO₄).

The term “synthetic gypsum” can be also referred to as “chemical gypsum,” or flue gas desulfurization (FGD) gypsum. Gypsum can be anhydrous or hydrous.

In this disclosure, the term “limestone” may be referred interchangeably with calcium carbonate or CaCO₃.

In one aspect, this disclosure relates to methods for using one or more copper-containing compounds in order to protect building construction composition, including those comprising hydrated gypsum, anhydrous gypsum and/or calcium carbonate, from spoilage by microbes. The building construction compositions may include but are not limited to joint compounds, ready-mixed joint compounds, paints, coatings, sealers, gypsum slurries, spackling compounds, wallboard gypsum slurries and wall and ceiling textures.

A copper-containing compound may be added to a dry building construction composition, or the copper-containing compound may be added to the building construction composition when the building construction composition is mixed with liquid components which may include water.

Preferred copper-containing compounds may include one or more of the following compounds: copper (II) sulfate pentahydrate, copper sulfate, copper hydroxide, copper oxychloride, or any combination thereof. Particularly preferred copper-containing compound is copper sulfate pentahydrate which may be referred interchangeably with copper (II) sulfate pentahydrate. Copper (II) sulfate pentahydrate is a chemical compound with the following chemical formula CuSO₄·5H₂O and having CAS number 7758-98-8. Preferably, the compound is in crystal form and has a dark blue color.

In the methods according to this disclosure, one or more of the copper-containing compounds may be mixed with dry components of a building construction composition, or the copper-containing compounds may be added together with water when a dry building construction composition is mixed with water.

In the methods according to this disclosure, the copper-containing compound, and in particular copper (II) sulfate pentahydrate, may be used in any amount sufficient to at least partially prevent, delay or inhibit bacterial growth in a building construction composition in comparison to the same building construction composition that does not contain the copper-containing compound or other bactericides. A bacterial growth may be scored by visual inspection. Technical advantages of the present methods include: these methods may be substantially VOC free and in particular substantially formaldehyde-free and also, the copper-containing compound may be used in concentrations higher than those allowable for antimicrobial compounds that comprise formaldehyde. In some embodiments, up to 10 wt % of the copper-containing compound may be used, while conventional antimicrobial compounds have to be used in concentrations lower than 1 wt % in order to decrease the presence of volatile organic compounds in a building construction composition.

In this disclosure, “protecting a building construction composition” from bacterial growth is understood broadly and includes at least a partial decrease or delay in bacterial growth in the building construction composition which comprises the copper-containing compound in comparison to a control building construction composition which does not comprise the copper-containing compound.

In order to measure bacterial resistance of the building construction composition according to this disclosure, the following method for rating bacterial resistance is followed by using sterile technique, as was described in U.S. Pat. No. 8,975,321. About 1×10⁶ bacterial cells such as for example as P. aeruginosa, E. acrogenes, E. coli, and/or B. subtilus in 1 ml sterile water are mixed with 100 grams of the aqueous mixture according to this disclosure, producing a sample for plating. A tryptic Soy Agar (TSA) 15 mm×100 mm plate is swabbed with the sample such that about 100 microliters of the sample are spread on the plate. Plates are incubated at 37° C. and examined for bacterial growth 2 to 7 days post plating. The following rating is then used for scoring plates:
Rating 1—few than 10 colonies
Rating 2—11-39 colonies
Rating 3—40-100 colonies
Rating 4—more than 100 colonies

In some embodiments, the methods according to this disclosure which incorporate the copper-containing compound into a building construction composition may protect the building construction composition, when aqueous, from bacterial growth by providing bacterial resistance of about 2 (11-39 colonies) or less, and preferably about 1 (less than 10 colonies) or even less when measured 2 days post-plating on tryptic Soy Agar (TSA) 15 mm×100 mm plates. These embodiments may include those in which the copper-containing compound comprises copper (II) sulfate pentahydrate, including in a concentration raging from about 0.1 wt % to about 10 wt %.

In some methods according to this disclosure, the copper-containing compound, preferably copper (II) sulfate pentahydrate, may be used instead of commonly used bactericides and in-can preservatives. In other embodiments, the copper-containing compound may be used together with one or more bactericides/fungicides and/or in-can preservatives commonly used in joint compounds and textures. Examples of such bactericides may include, but are not limited to, hexahydro-1,3,5-tris(2-hydroxyethyl)-s-triazine and/or 1,3-Bis(hydroxymethyl)-5,5-dimethylimidazolidine-2,4-dione. However, as these and many other conventional antimicrobial compounds may include VOC-generating formaldehyde and/or some other solvents which generate VOC, using the copper-containing compound, preferably copper (II) sulfate pentahydrate, according to this disclosure may at least decrease an amount of formaldehyde-containing biocides, if not eliminate them completely from the building construction composition.

In some preferred embodiments, the copper-containing compound may be used in combination with one or more fungicides in order to prevent a fungal growth. Preferred fungicides may include zinc dimethyldithiocarbamate which can be used in any suitable amount, for example from about 0.125 wt % to about 3 wt %, and more preferably from about 0.25 wt % to about 1 wt %.

Within the scope of methods and compositions according to this disclosure, the copper-containing compound, preferably copper (II) sulfate pentahydrate, may be used in any amount sufficient to at least partially inhibit for at least a period of time at least some bacterial growth in a building construction composition after the building construction composition has been mixed with water. In some preferred embodiments, the copper-containing compound may be used in an amount from about 0.1 wt % to about 10 wt %, and preferably from about 0.1 wt % to about 5 wt % and most preferably from about 0.1 wt % to about 1 wt % by weight of dry components in the building construction composition.

It has been unexpectedly found that the copper-containing compounds, preferably copper (II) sulfate pentahydrate, may be used advantageously for replacing other biocides which contain formaldehyde. Thus, compositions and methods according to this disclosure may containing a lesser amount of formaldehyde, if at all, and in some embodiments, the compositions may be classified as low VOC (less than 1000 ppm) or even zero-VOC products.

Preferably, the building construction compositions according to this disclosure may comprise hydrated gypsum, anhydrous gypsum, and/or calcium carbonate.

The building construction compositions according to this disclosure include dry powder compositions as well as aqueous compositions which may also include a slurry or a paste.

For example, joint compounds or wall and ceiling textures according to this disclosure include dry powder formulations which may be mixed with water and optionally with some other additives at a construction site prior to application. One of the technical advantages of compositions and methods according to this disclosure is that it has been unexpectedly found that formulating dry powder compositions with the copper-containing compound, preferably copper (II) sulfate pentahydrate, prevents completely or at least somewhat delays the onset of bacterial growth after the wall and ceiling texture is mixed with water. Accordingly, it is possible to mix a mixture at a construction site, such as for example as a wall and ceiling texture that comprises the copper-containing compound, preferably copper (II) sulfate pentahydrate, with water in a larger batch which may be used over a period of several days, such as for example for one workday, two workdays, up to five workdays or even longer. Thus, compositions and methods according to this disclosure save workhours because mixing of a new batch may be needed less often. The methods and compositions according to this disclosure also result in a more efficient use of building construction materials because these methods and compositions may minimize or even eliminate the need to dispose of unused mixtures after one day of work is completed.

The building construction compositions may include wall and ceiling textures which may be used for producing a surface with a pattern, joint compounds which may be used for filling gaps (joints) between adjacent dry wall panels, ready-mixed joint compounds which are premixed with water and also useful for filling gaps (joints) between adjacent dry wall panels, paints which can be useful for coating a surface into a particular color, sealants, coatings which can be useful for coating a surface and protecting it from for example bacterial growth, gypsum slurries which are used for forming gypsum wallboards, spackling compounds which can be used for patching wall defects and gypsum plaster which can be useful for finishing wall surfaces. In some preferred embodiments, the building construction composition according to this disclosure may be formulated as a wall and ceiling texture.

The building construction compositions may comprise at least a filler, a binder and the copper-containing compound, preferably copper (II) sulfate pentahydrate. Suitable binders include, but are not limited to, a latex binder, natural starch, synthetic starch, pregelatinized starch, polyvinyl alcohol, polyvinyl acetate, polyvinyl acrylate, ethylene vinyl acetate, styrene acrylic copolymers.

In some preferred embodiments, the binder may be used in an amount from about 0.1 wt % to about 50 wt % of the wall and ceiling texture, and preferably from about 0.5 wt % to about 20 wt % and most preferably from about 5 wt % to about 15 wt %.

The filler may include one or more of the following, but not limited to: calcium carbonate, dolomite, clay which may preferably include attapulgite clay, talc, mica, magnesium aluminum silicate, gypsum, perlite, pyrophyllite, glass beads, and/or plastic beads, or other inert fillers. Preferably, the filler includes at least calcium carbonate, hydrated gypsum, anhydrous gypsum which can be used in any suitable amounts, such as for example as from about 30 wt % to about 90 wt %, and more preferably from about 40 wt % to about 80 wt % and most preferably from about 50 wt % to about 70 wt %. Other fillers such as attapulgite clay, talc, mica, magnesium aluminum silicate, gypsum, perlite, expanded perlite, glass beads and/or plastic beads may be used in any suitable amounts, such as for example as from about 0.5 wt % to about 40 wt %, and more preferably from about 1 wt % to about 10 wt % and most preferably from about 2 wt % to about 10 wt %.

At least some compositions according to this disclosure may further comprise one or more additives which may include one or more of the following: a rheology modifying agent, a coloring pigment, a surfactant, a defoamer, fungicide, co-preservative and/or a thickener.

Examples of suitable thickeners include cellulose-based thickeners, preferably cellulose ethers in which one or more secondary hydroxyls are replaced by another group, such as for example, methylcellulose, propyl methylcellulose, hydroxyethylcellulose, carboxymethylcellulose, and cellulose-based gums, such as, for example, as pectin and/or xanthan. In embodiments, the thickener can be used in any suitable amount, such as for example, from about 0.05 wt % to about 5 wt % and more preferably from about 0.1 wt % to about 2 wt %.

Suitable rheology modifying agents may include one or more clays and in particular attapulgite clay, hydrophobically modified alkali-soluble emulsion polymers (HASE), alkali-soluble emulsion polymers (ASE), hydrophobically modified ethoxylated urethane polymers (HEUR), kaolin and/or sepiolite. Examples of ASE and HASE polymers include those described in U.S. Pat. Nos. 5,292,843; 7,378,479; and 8,969,261. In embodiments, the rheology modifying agent can be used in any suitable amount, such as for example, from about 0.05 wt % to about 5 wt % and more preferably from about 0.1 wt % to about 2 wt %.

Other additives may include mica or talc which can be used in order to minimize cracking, which can be used any suitable amounts, such as for example as from about 0.5 wt % to about 15 wt %, and more preferably from about 1 wt % to about 10 wt % and most preferably from about 2 wt % to about 10 wt %.

One or more coloring pigments may be added in order to obtain a building construction composition of desirable color, e.g., white, off-white, yellow, or any other color. The amount of pigment to be added, depends on a pigment type and a color to be produced.

A surfactant, such as a soap, e.g., sodium stearate, lignin sulfonate, alkylphenol ethoxylate and/or alkylphenol ethoxylate may be added in order to improve dispersion of the building construction composition. In embodiments, from about 0.05 wt % to about 5 wt % and more preferably from about 0.1 wt % to about 2 wt % of the surfactant may be used.

A defoamer may be used in order to reduce the formation of foam during mixing with water. Suitable defoamers include, but are not limited to, silicon-based defoamers, alkyl polyacrylates among others. In embodiments, from about 0.05 wt % to about 3 wt % and more preferably from about 0.1 wt % to about 1 wt % of the defoamer may be used.

In some embodiments, the wall and ceiling textures or joint compounds according to this disclosure can be prepared as a dry powder and then mixed with water and/or solvents by a user prior to application to a substrate. When used with water, from about 30 to about 80 parts of water by weight and preferably from about 40 to about 70 parts of water by weight and most preferably from about 50 to about 65 parts of water by weight can be used for 100 parts of the building construction composition according to this disclosure. For wall and ceiling textures, an amount of water to be added depends on a texture pattern to be produced and an application method.

In yet another aspect, this disclosure relates to a method for finishing an interior wall and/or ceiling surface, wherein the method may comprise:
a) mixing a wall and ceiling texture powder with water and a copper-containing compound, wherein said wall and ceiling texture powder comprises one or more of the following: calcium carbonate, hydrated gypsum, anhydrous gypsum, starch, a polymeric binder, or any combination thereof; and
b) applying the mixture over an interior wall and/or ceiling surface and forming a texture pattern over said surface.

In some embodiments, in step a), the wall and ceiling texture powder may be premixed with the copper-containing compound prior to be mixed with water. Preferred embodiments of this method include those, in which step b) includes spraying the mixture, applying the mixture with a brush, applying the mixture with a roller, or any combination thereof. In some embodiments, the method may further comprise a step of coating the interior wall and/or ceiling surface with one or more coatings of a latex paint prior to step b). In some embodiments, the method may further comprise painting over the texture pattern after the texture pattern has dried. Preferably, the copper-containing compound may include one or more of the following: copper (II) sulfate pentahydrate, copper sulfate, copper hydroxide, copper oxychloride, or any combination thereof. Preferably, the copper-containing compound may be added in an amount from about 0.1 wt % to about 10 wt % of the wall and ceiling texture powder.

In some embodiments, the compositions according to this disclosure, such as joint compounds or wall and ceiling textures may be applied by a brush, with a roller, by airless or conventional spraying to a substrate. Joint compounds may be used for filling joints between two wall panels. Wall and ceiling textures may be used for applying over an interior wall or ceiling surface in order to produce a pattern, such as for example as orange peel or popcorn.

Building construction mixtures according to this disclosure may be mixed in a mixer which in embodiments, may include a mixing vessel equipped with a variable speed power agitator.

Thus, in yet another aspect this disclosure relates to methods by which mixers, such as a manufacturing plant mixer or a construction site mixer may be cleaned between production of different mixtures. It has been unexpectedly found that contacting the mixer between uses with the copper-containing compound according to this disclosure protects the mixer from microbial growth, which can be advantageous and result in longer time periods between cleanings.

In these methods, the mixer may be contacted with one more of the copper-containing compound prior to using the mixer and/or after mixing in the mixer has been completed. In some embodiments, the copper-containing compound, preferably comprising copper (II) sulfate pentahydrate, may be premixed with water prior to contacting the mixer. In other embodiments, the copper-containing compound may be added as a powder to the mixer. The mixer can then be filled with water, and then optionally further rinsed with water. An amount of the copper-containing compound to be used may vary, but typically the copper-containing compound may be used in a mount ranging from about 0.1% to about 10% by weight of the copper-containing compound to the volume of the mixer.

Further embodiments include the following non-limiting examples.

### Example 1

The follow dry wall and ceiling texture was prepared as composition 1:
a. Limestone <95%
b. Mica <15%
c. Attapulgite <5%
d. Bentonite <5%
e. Kaolin <5%
f. Perlite <5%
g. Starch <5%
h. Polyvinyl alcohol <5%

Copper sulfate II Pentahydrate was mixed with the texture composition 1 in the amounts shown in Table 1 below. The textures were mixed with water and tested for sterility.

Samples were plated on TSA or PDA plates and incubated for 2 days at room temperature. The plates were scored on the following rating scale:
Rating 0=No Growth on sample surface
Rating 1 <10 colonies
Rating 2 11-39 colonies
Rating 3 40-100 colonies
Rating 4 >100 colonies

Results of these studies are reported in Table 1 below.

TABLE 1
Microbial Growth Testing

| | TSA |
|---|---|
| Description | Plates |
| Sample 1 contains composition 1 plus W | 0 |
| Copper sulfate II Pentahydrate 0.1% | |
| Sample 2 contains composition 1 plus W | 1 |
| Copper sulfate II Pentahydrate 0.1% | |
| Sample 3 contains composition 1 plus W | 0 |
| Copper sulfate II Pentahydrate 0.1% | |
| Sample 4 contains composition 1 and no | 4 |
| biocide | |
| Sample 5 (control) contains composition | 4 |
| 1 plus a formaldehyde releasing dry | |
| biocide comprising hexahydro-1,3,5- | |
| tris(2-hydroxyethyl)-s-triazine | |

### Example 2

A dry powder wall and ceiling composition according to this disclosure was tested for dry bacterial growth on tryptic soy agar (TSA) plates. The composition contained about 48 wt % calcium carbonate and about 5 wt % binder. About 0.125 wt %, 0.25 wt %, 0.5 wt % or 1 wt % of Copper sulfate II Pentahydrate was added to the composition. 65 mL of water to 100 g of sample was used to mix the compound. Samples were then tested as follows: a quarter sized button of material was dried on a non-stick substrate. The button was placed in the center of a sterilized plate containing TSA. A mixed culture of ATCC #: 10145 Pseudomonas aeruginosa, ATCC #: 35655 Alcaligenes faecalis, ATCC #: 13048 Klebsiella aerogenes, and ATCC #: 11229 Escherichia coli at a concentration of 1×10⁶ CFU/mL was applied as a vapor over the surface of the agar and button.

Results of this experiment are listed in Table 2 below, wherein a zone of inhibition was measured in mm. Plates were scored according to the following scale:
0=No Growth on sample surface
1=1-10% growth on sample surface
2=11-30% growth on sample surface
3=31-60% growth on sample surface
4=>61% growth on sample surface
Zone=Zone of inhibition measured in mm

TABLE 2
Microbial Growth Testing in Dry Composition

| | 2 Days | | 7 days | | 14 days | | 21 days | |
|---|---|---|---|---|---|---|---|---|
| Description | zone | rating | zone | rating | zone | rating | zone | rating |
| Sample comprising 0.125% copper sulfate | 2 | 0 | 1 | 0 | 1 | 0 | 0 | 1 |
| Sample comprising 0.25% copper sulfate | 2 | 0 | 1 | 0 | 1 | 0 | 0 | 1 |
| Sample comprising 0.5% copper sulfate | 2 | 0 | 1 | 0 | 1 | 0 | 0 | 1 |
| Sample comprising 1.0% copper sulfate | 2 | 0 | 1 | 0 | 1 | 0 | 0 | 1 |

We claim:

1. A building construction composition comprising:
hydrated gypsum, anhydrous gypsum, and/or calcium carbonate;
a starch and/or polymeric binder; and
a copper-containing compound.

2. The building construction composition of claim 1, wherein the building construction composition is in the form of a wall and ceiling texture, joint compound, paint, sealant or coating.

3. The building construction composition of claim 1, wherein the composition comprises:
hydrated gypsum, anhydrous gypsum and/or calcium carbonate in an amount from about 30 wt % to about 90 wt % of the composition;
the starch and/or polymeric binder in an amount from about 0.1 wt % to about 50 wt % of the composition; and
the copper-containing compound in an amount from about 0.1 wt % to about 10 wt % of the composition.

4. The building construction composition of claim 1, wherein the copper-containing compound is one or more of the following compounds: copper (II) sulfate pentahydrate, copper sulfate, copper hydroxide, copper oxychloride, or any combination thereof.

5. The building construction composition of claim 1, wherein the building construction composition further comprises water.

6. The building construction composition of claim 1, wherein the building construction composition further comprises one or more of the following additives: a rheology modifying agent, a coloring pigment, a surfactant, a defoamer, fungicide, co-preservative, a thickener or any combination thereof.

7. The building construction composition of claim 1, wherein the building construction composition is substantially formaldehyde free.

8. The building construction composition of claim 1, wherein the building construction composition has a bacterial resistance of about 1 or less as measured 2 days post-plating on Tryptic Soy Agar (TSA) 15 mm×100 mm plate.

9. A method for protecting a building construction composition which comprises one or more of hydrated gypsum, anhydrous gypsum and/or calcium carbonate, and one or more of a starch and/or polymeric binder from bacterial growth, wherein the method comprises: mixing the building construction composition with a copper-containing compound.

10. The method of claim 9, wherein the copper-containing compound is one or more of the following: copper (II) sulfate pentahydrate, copper sulfate, copper hydroxide, copper oxychloride, or any combination thereof.

11. The method of claim 9, wherein the copper-containing compound is added in an amount from about 0.1 wt % to about 10 wt % of the building construction mixture.

12. The method of claim 9, wherein the building construction composition is being mixed with water in a mixer and the copper-containing compound is added to the mixer directly, or the copper-compound is premixed with dry components of the building construction composition before being added to the mixer.

13. The method of claim 9, wherein the building construction composition is a dry mixture which does not contain water or liquid components.

14. A method for finishing an interior wall and/or ceiling surface, the method comprising:
a) mixing a wall and ceiling texture powder with water and a copper-containing compound, wherein said wall and ceiling texture powder comprises one or more of the following: calcium carbonate, hydrated gypsum, anhydrous gypsum, starch, a polymeric binder, or any combination thereof; and
b) applying the mixture over an interior wall and/or ceiling surface and forming a texture pattern over said surface.

15. The method of claim 14, wherein the method is further characterized by one or more of the following features:
in step a), the wall and ceiling texture powder is premixed with the copper-containing compound prior to be mixed with water;
step b) includes spraying the mixture, applying the mixture with a brush, applying the mixture with a roller, or any combination thereof;
the method further comprises a step of coating the interior wall and/or ceiling surface with a latex paint prior to step b);
the copper-containing compound includes one or more of the following: copper (II) sulfate pentahydrate, copper sulfate, copper hydroxide, copper oxychloride, or any combination thereof; and/or
the copper-containing compound is added in an amount from about 0.1 wt % to about 10 wt % of the wall and ceiling texture powder.

16. A method for producing a building construction mixture in a mixer, the method comprising:
a) mixing with water in the mixer the building construction composition of claim 1; and
b) prior to step a) and/or after step a) contacting the mixer with a copper-containing compound.

17. The method of claim 16, wherein the method is further characterized by one or more of the following features:
the copper-containing compound comprises copper (II) sulfate pentahydrate; and/or
the copper-containing compound is pre-mixed with water prior to contacting the mixer.
